(19) United States
(12) Patent Application Publication
(10) Pub. No.: US 2009/0265688 A1
(43) Pub. Date: Oct. 22, 2009

(54) Circuits and methods for mobility of effectful program fragments

(76) Inventors: Paul Govereau, Somerville, MA (US); Kevin J. Redwine, Somerville, MA (US); Kelly T. Heffner, Somerville, MA (US)

Correspondence Address: THOMPSON & KNIGHT, L.L.P.;PATENT PROPERTY DEPARTMENT, 1722 ROUTH STREET, SUITE 1500, DALLAS, TX, 75201-2533, US

(21) Appl. No.: 12/386,239

(22) Filed: Apr. 15, 2009

Related U.S. Application Data
(60) Provisional application No. 61/124,625, filed on Apr. 18, 2008.

(51) Int. Cl. G06F 9/44; G06F 9/445

(52) U.S. Cl. 717/124; 717/176; 717/174

(57) ABSTRACT

Methods for mobility of effectful program fragments including a method for serializing and deserializing effectful program fragments, and a method for utilizing a program fragment in a type-directed way.

### CROSS-REFERENCE TO RELATED APPLICATION

The present application claims the benefit of U.S. Provisional Patent Application Ser. No. 61/124,625, filed Apr. 18, 2008.

### FIELD OF INVENTION

The present invention relates in general to programming languages, compilers, interpreters, and type theory techniques, and in particular, to serialization and deserialization of code and data with effects (pointers, references, input/output operations, and the like).

### BACKGROUND OF INVENTION

Computer networks are ubiquitous in today's society and support a wide range of business and social activities. Among other things, networked computers implement familiar communications services such as email, electronic messaging, and audio and video exchanges. Besides forming the communications backbone for virtual communities and online social networks, these computer-based services have become vital to the communications infrastructure for a wide range of businesses, as well as scientific and academic institutions.

In addition to communications, networked computers have also functionally replaced many of the mainframe computer systems that formerly were necessary for implementing complex computing and data management tasks. For example, computer networks can implement distributed and concurrent processing, which allow multiple processors to participate in the execution of a given algorithm or task.

Operating and controlling a networked computer system present a number of significant challenges, particularly when resources are being shared. For example, when multiple processors or processes are participating in a task or transaction, shared variables, shared memory, or both must be efficiently managed to ensure that participating machines are operating on the most up-to-date data. Furthermore, the machines participating in the task or transaction must have the requisite programs or program fragments necessary for executing their assignments. Finally, overall system operation should not rely on overly complicated protocols, while still ensuring that the desired actions or computations are carried out in an accurate and efficient manner.

Implementations of modern programming languages rely on sophisticated runtime environments to provide support for features like garbage collection, lightweight threads, and transactional memory. However, we find lacking support for a fully automated method of serializing code that can be transferred and run in different instances of a program.

A programming language implementation also comes with a set of libraries basic to the operation of code written in those languages. Among the kinds of libraries that are often included are networking primitives and serialization support. However, this level of basic support does not provide for a fully-automated serialization and deserialization mechanism.

From a programmer perspective, existing languages do not provide a simple way to serialize and deserialize expressions. The reason that programmers see such complexity is that serializing and deserializing effectful expressions is difficult to automate. This is true even of modern programming languages like Java, which leave the semantics of serialization of effects up to the programmer.

The difficulty of serializing effectful expressions has a near analog with creating deep versus shallow copies of an object. An easy default is to perform a shallow copy, and if a deep copy is required then the programmer must assist the language implementation.

In addition, taking Java as an example again, serialized code is deserialized as an instance of class Object, and hence the receiver will need to cast the object—a potentially unsafe operation—serialized expressions need to carry information that says what class they are, and the class needs to be present on the machine. The receiving function will need to accept an arbitrary type of serialized data and to reconstruct it correctly it needs to determine what class to try to deserialize and cast to. The receiving program must know what it is going to do with the deserialized program fragment.

### SUMMARY OF INVENTION

According to one embodiment of the principles of the present invention, a method is disclosed for dispatching on a function call of a selected type during execution of software code by a computer system, which includes searching an available set of code based on at least function name for candidate code for implementing a selected function. If candidate code is found, unification is performed on type variables within the candidate code to determine the suitability of the candidate code, and if the type variables unify, the a dispatch is performed to the candidate code to implement the selected function. On the other hand, if candidate code is not found, the set of available code is dynamically expanded and searching is performed for candidate coded in the expanded set of available code.

A method is also disclosed for determining whether a variable name within a set of software code being executed on a computer is associated with a path, which includes testing if the variable name is defined within the code but outside a code module referencing the variable name. If the variable name is defined outside the code module referencing the variable name, a determination is made as to whether that variable name is an external variable name associated with a path. If the variable name is defined within the code module, then testing is performed to determine if the variable name can be referenced by code outside of the code module defining the variable name. If the variable name can be referenced by code outside of the code module defining the variable name, then a determination is made that variable name is a public variable name associated with a path. if the variable name cannot be referenced by code outside of the code module defining the variable name, a determination is made that the variable name is a not public variable name and is not associated with a path.

In another embodiment of the principles of the present invention, a method is provided for serializing an expression defined in programming code running on a computer into binary data. The expression is tested with the computer and serialization operations are selectively performed with the computer in response to testing the expression. In particular, if the expression is a path, the path is encoded. If the expression is a variable, then the variable is serialized. If the expression if a program fragment, then program fragment is serialized. Finally, if the expression has free variables, the free variables are localized.

A corresponding method of de-serializing binary data with a computer to generate an expression in a corresponding programming code is also disclosed, which includes testing the binary data with the computer and selectively performing de-serialization operations with the computer in response. In particular, if the binary data can be decoded as a path, then the binary data is decoded as a path, but if the binary data cannot be decoded as a path but can be decoded as a variable, the binary data is decoded as a variable. Furthermore, if the binary data cannot be decoded as either a path or a variable, but can be decoded as a program fragment, then the binary data is decoded as a program fragment.

The principles of the present invention are also embodied in a method of installing software on a computer, in which binary data are received from an external source by a computer. The binary data are de-serialized and a dispatch is performed to retrieve code for operating on the de-serialized data. The retrieved code is installed on the computer for operating on the de-serialized data.

Finally, the present principles provide for a method of exchanging program code via a network using zero-configuration software, which includes designating with a plurality of machines participating in zero-configuration a single overloaded function name as an entry point into programming code, the overloaded function name corresponding to a entry point function which takes a parameter. A non-public datatype is defined on a first computer, which also overloads the designated entry point function with a program fragment for the non-public datatype. The first computer then serializes the program fragment defined by applying the entry point function to the non-public datatype. The serialized program fragment is sent from the first computer to a second computer via the network. The second computer receives and deserializes the serialized program fragment and selectively runs it as program fragment with network-aware open dynamic dispatch.

Advantageously, the embodiments of the principles of the present invention provide for the implementation of efficient networked systems. Among other things, these principles allow networked computers to exchange not only data, but also the programming expressions, program fragments, and programs need to allow for computers operating on a network efficiently collaborate. Moreover, provisions are made which allow a computer obtain necessary program fragments “on demand”, such that a given computer need only start with a minimal set of programming code.

### BRIEF DESCRIPTION OF DRAWINGS

For a more complete understanding of the present invention, and the advantages thereof, reference is now made to the following descriptions taken in conjunction with the accompanying drawings, in which:

FIG. 1 shows an overview the dependencies between different aspects of the present inventive principles. An arrow from A to B means that B requires A.

FIG. 2 shows the steps to open dynamic dispatch.

FIG. 3 shows the steps of a method for determining if a variable name is a path according to the present principles.

FIG. 4 shows the steps of a serialization process according to the present principles.

FIG. 5 shows the steps to determine if an expression is a path for language implementations that do not make paths part of the core language.

FIG. 6 shows the steps of serializing a variable name according to the present principles.

FIG. 7 shows the steps of serializing a fragment according to the present principles.

FIG. 8 shows the steps to serialize a binding according to the present principles.

FIG. 9 shows the steps of localizing a fragment according to the present principles.

FIG. 10 shows the optional steps of user encoding that may be taken when using a typed language according to the present principles.

FIG. 11 shows the steps of a deserialization process according to the present principles.

FIG. 12 shows optional steps of user decoding that may be taken when using a typed language according to the present principles.

FIG. 13 shows the steps for network-aware open dynamic dispatch according to the present principles.

FIG. 14 shows the steps for automatic software installation in response to events according to the present principles. and

FIG. 15 shows the steps of zero-configuration software according to the present principles.

### DETAILED DESCRIPTION OF THE INVENTION

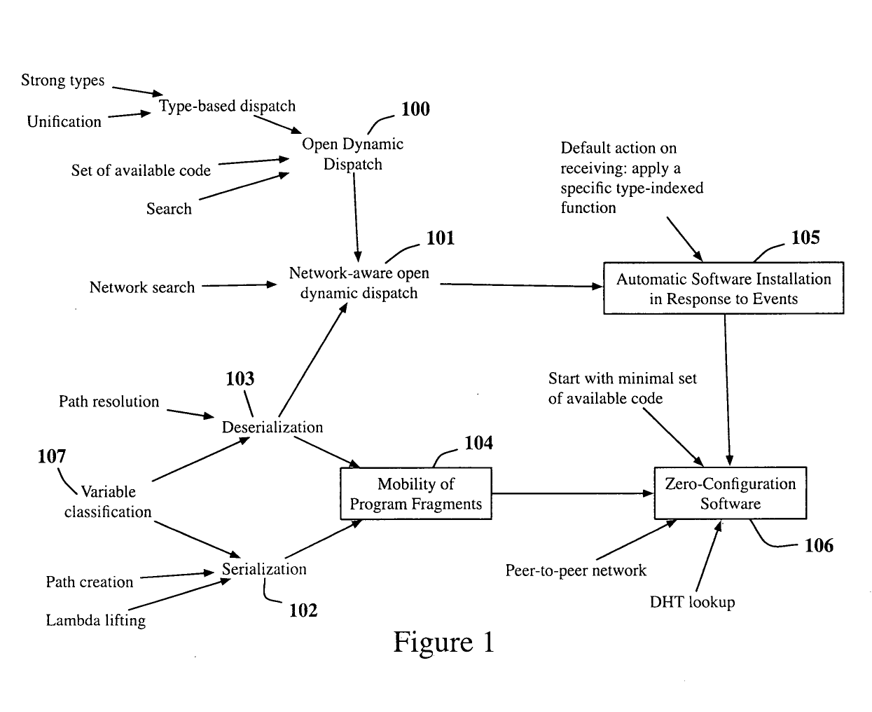

The principles of the present invention and their advantages are best understood by referring to the illustrated embodiment depicted in FIGS. 1-15 of the drawings, in which like numbers designate like parts.

The embodiments of the principles of the present invention advantageously allow data to be easily moved between programs. That is, data values can be sent from one program to another, with the run-time system providing all of the data conversion mechanisms transparently to the programmer. In addition to this basic feature, programmers can send a computation, or a partially evaluated computation that exists in their environment, to another computer over a network, and that computer can continue the computation in the remote environment.

As an example, consider a presence environment where Bob runs a buddy list application that displays the status of each user graphically. Bob's buddy list application sends Alice a request for her status icon. Each one of Bob's buddies decides how they would like their status to be shown. Unlike a traditional buddy list, this buddy list leverages Mobile Program Fragments. Rather than needing to program a buddy list that understands many protocols containing the vast variety of data each of Bob's buddies wants to convey in their status, Mobile Program Fragments allows each user to define their status as a computation.

Then, since Alice has previously set her status icon to be a colored sphere to represent how busy she is, along with the current time where she is located, Alice's chat program creates a closure by partially applying the arguments of Alice's busy status and the current system time for the function to draw her status icon.

Alice's chat program sends the resulting closure to Bob, using the same mechanism as sending traditional data values. Bob's virtual machine receives the closure, type checks it, and hands the closure off to Bob's buddy list application. The buddy list application can then use the closure to display Alice's status.

Advantageously, the concept of user status is now highly customizable without any pre-planning by protocol designers; furthermore, new ideas can be integrated without changing a line of code. Using types to guarantee that the computations only behave in certain desired ways (such as rendering to the screen), we also get a safety guarantee from customizable messages that a bloated protocol could never offer.

The principles of the present invention are also embodied in zero-configuration software that allows new software (including all of its dependencies) to be automatically transferred from one computer to another and installed on the receiving computer with no user interaction required. For example, zero-configuration software may be used to download software from an automated agent as well as to receive software from a contact on the network.

For example, Alice wants to send a word processing application to Bob. Alice's virtual machine packages the document editor as a computation, including every dependency that computation has. When software is going to be transferred over the network, such as in our example between Alice and Bob, Alice must be sure to send Bob all of the dependencies that the software itself needs to function.

In particular, Alice's virtual machine computes the dependencies of the program that Alice wants to send, and packages them up into the software Bob's virtual machine receives the software from Alice, and recognizes what it received as an application. There are no decisions necessary to guide the installation of the software, so Bob's virtual machine can add the software to Bob's machine without interaction from Bob.

Thus, with zero-configuration software, the act of sharing software is identical to the act of sharing data.

In addition, to zero-configuration software, the present principles are also embodied in a process in which software can be installed “on demand”. By “on demand”, we mean that software is installed when the virtual machine receives data, but does not have software capable of interpreting it.

In this case, Alice has a document that she would like to edit collaboratively with Bob, so Alice sends the document to Bob. Bob's virtual machine receives the document data, but doesn't have an application that can receive data of that type. Without any interaction by Bob, his virtual machine receives the data, and recognizes that Bob does not have any software that understands the data. Bob's virtual machine then sends a request to Alice's virtual machine asking for an application that understands data of the type it sent. The Automatic Software Installation Process builds on the idea that, if Alice sent the data to Bob, it is most reasonable to look to Alice's virtual machine for the software to understand that data.

Alice's virtual machine then sends the document editor program to Bob's virtual machine using zero-configuration software. Bob's virtual machine receives the word processing application, recognizes it as a application that can receive values of the desired type, and launches it to read the original value.

We describe several processes that can act individually or in combination. FIG. 1 shows an overview of the dependencies between our methods generally described above. Each separate node can be considered its own individual method that only relies on methods from incoming arrows (if A points to B then B relies on A). In addition, whenever nodes are linked in this graph we may also create a new process by combining them. In what follows we discuss each of the labeled nodes in detail, along with their dependencies.

In Section A we describe our methods to enable what we have termed “open dynamic dispatch”, represented by node 100 in FIG. 1. Open dynamic dispatch depends on type-based techniques, so we give an overview of these in Section A.1. Open dynamic dispatch also depends on having a set of available program fragments, and we describe this requirement in Section A.2. In Section B we describe our methods to enable mobility of program fragments, represented as node 104. The method of node 104 depends on our methods for serialization and deserialization (nodes 102 and 103) that both depend on the concept of a “path”. We first describe paths in Section B.1, then we describe what program fragments are in Section B.2, then serialization in Section B.3 and deserialization in Section B.4. In Section C we use our methods for open dynamic dispatch (node 100) along with the ability to search over a network and deserialize program fragments (node 103) to create a method enabling what we term “network-aware open dynamic dispatch” (node 101). In Section D we describe our method for automatic software installation in response to events (node 105) that uses network-aware open dynamic dispatch (node 101). In Section E we describe our method for zero-configuration software (node 106) which allows us to start with a very minimal set of available code—this depends on mobility of program fragments (node 104), automatic software installation in response to events (node 105), as well as being connected to a peer-to-peer network with some representation of a distributed set. One exemplary implementation uses a standard DHT mechanism such as Kademlia (Petar Maymounkov et al., Kademlia: A Peer-to peer information system based on the XOR metric, First International Workshop on Peer-to-peer Systems, 2002).

One implementation of our methods is in use for a programming language of our own design, the compiler for which is written in the Haskell programming language. For convenience we use pseudocode based on Haskell syntax throughout our descriptions. There is nothing specific to our methods that require Haskell, or a Haskell-like language. Haskell is one of several languages that have a strong, static typing discipline. In alternate embodiments, alternate programming languages may be used. Haskell is also a functional programming language, which we have found to be particularly convenient for implementation of programming languages. See Peyton Jones et al, Practical type interference for arbitrary-rank types, Journal of Functional Programming, 17 (1):1-82, 2007 for a full description of the type system used in Haskell. Further information about the language can also be found at haskell.org.

In order to use our methods, the language runtime, compiler, or interpreter needs a way of analyzing programs, either statically or dynamically. In one implementation of our methods this is accomplished at compile time by using the analysis already performed during type inference, a well-known procedure for many languages.

A. Open Dynamic Dispatch

Some languages include one or more dispatch mechanisms. These mechanisms are used to disambiguate a function call when a function name might be overloaded. The techniques can be applied statically, as is the case for Haskell's typeclass mechanism, or dynamically at runtime as is the case in Java's dynamic dispatch mechanism. In either case we are limited by what is called the “closed world assumption”. These methods assume that at the time the function call happens (or in the case of Haskell's mechanism, when the linker runs) we are aware of all the overloadings that may need to be considered to disambiguate the function call. There is a range of closed or openness in languages, Haskell is “more open” than some languages, for example. Our methods provide a means to be even more open by actively searching for code that we might possibly dispatch to.

Our method operates at runtime as opposed to the static, compile-time disambiguation of Haskell, and it removes the closed world assumption, enabling a language to search for overloadings that are not currently present in the runtime environment.

Our method relies on having a type-based dispatch mechanism, a set of available code to dispatch a function call to, an operation to search the set of available code for a good match, and a mechanism for searching for new code that might be dispatchable to. The set of available code must also be capable of growing dynamically.

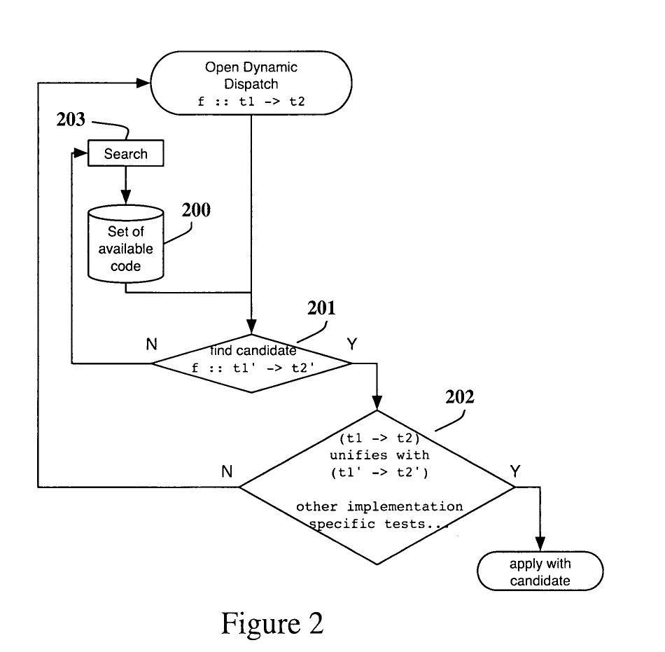

The steps in our method are illustrated in FIG. 2. Suppose that we wish to perform open dynamic dispatch on a function called “f”, which has the type t1->t2. The method begins by accessing the set of available code (node 200) to find candidate implementations of “f”. Each is provided with its type to block 201 where we determine if it is indeed a candidate (it must have the same name at a minimum). If there are no available candidate implementations then 201 goes to 203. In this case our set of available code failed to contain a candidate implementation and we will try, in 203 to grow our set of available code in hopes that a candidate will be found. This process can be repeated as many times as progress is made (the set of available code actually grows). If we do not make progress then the open dynamic dispatch process fails and this may be handled, for example, by throwing an exception. If we do find a candidate in 201 then it is passed on to 202 for further testing. In 202 we run unification (a well-known technique). Unification attempts to produce a substitution for type variables in the types t1->t2 and t1′->t2′ that would make these types look the same. If that substitution can be defined then these types are said to unify. Unification is a necessary condition for applying a candidate implementation. It need not be sufficient, however. An exemplary implementation of our methods also requires that, in addition to unifying, if there are many candidates then we select the most specific type (a substitution that retains the fewest type variables). Another exemplary implementation adds to this requirement that functions in the set of available code have not only type information but version numbering information, and that when choosing between several candidate implementations we use the highest version number.

A.1. Typed Languages

Some of the methods we disclose do not strictly require a strongly typed language: for example, serialization and deserialization do not require strong typing even though implementation is simpler with a typed language. Open dynamic dispatch, however, does require types. The language implementation in which open dynamic dispatch will be incorporated must be able to tell, for every expression in the language, what the type of that expression is.

Type systems tend to come in two broad categories: nominal and structural. In a nominal type system the programmer invents a name for each new type and if two expressions have types with the same name then they have the same type. In a structural type system the types are not merely names. Instead the types reflect the structure of the datatypes they summarize. Furthermore, many type systems allow type variables, and these interact in interesting ways with the question of whether two expressions have the “same type”. More precisely, if one expression yields a well-typed program in a context then the other expression will also yield a well-typed program in the same context. Moreover, systems with type variables may allow higher-order types—that is, types parameterized by other types.

Technically, we require one well-studied operation to be available at the type level: unification. For an overview of unification for simple languages see, for example, Benjamin C. Pierce, Types and programming language, MIT Press, Cambridge, Mass., USA, 2002. Unification for a purely nominal type system is just a matter of comparing symbols for equality, for a structural type system it is more interesting. An exemplary implementation of our techniques uses a structural type system with higher-order types. Higher-order types are helpful in the implementation of our methods, especially in classifying variables for serialization and deserialization as we discuss in Section B.3.

One last requirement for a typed language is that it allows overloading in some form. In Java, for example, this happens by the subclassing mechanism. In Haskell on the other hand it happens by the typeclass mechanism. Our methods will work with any overloading mechanism, although an exemplary implementation is closer to the Haskell system. Dynamic dispatch only makes sense for a language that provides overloading.

A.2. Available Code

Different languages and computer architectures provide for different ways of combining code, be it statically or dynamically. Statically, a compiler might link two object code files together in order to create a single monolithic executable. At runtime other techniques could be used. Dynamically linked libraries can be loaded into memory at runtime to provide definitions for symbols that a main program requires, for example. Or in a JIT compilation environment you might have special code, like Java's classloader mechanism, to load and compile bytecode files on-the-fly and make them available. In an interpreted language the mechanism is likely much simpler—-one can just load the source code to the interpreter, perhaps type check, and merge the definitions into the global environment.

We require a dynamic mechanism for our methods. Our methods are agnostic to the underlying mechanism, except that it must be able to provide type information when loading the code into the set of available code. While any of these standard techniques could be made to work, one exemplary implementation uses an interpreter and runs a type inference algorithm when reading in the source code, which is then used to populate the set of available code. All variable names and types become fully-qualified paths.

The set of available code also must provide a search mechanism. We require the ability to inspect the type of each name in the set. Although both nominal and structural types, and first-order as well as higher-order types can be supported by our methods, an exemplary implementation uses higher-order structural types.

B. Mobility of Program Fragments

Our methods enable a programming language to support fully-automated serialization and deserialization of program fragments. The following subsections describe our methods. First we discuss two basic concepts: paths and program fragments. Then we explain a method for classifying variables, which is used both in serialization and deserialization. Then we describe the serialization and deserialization methods.

B.1. Paths

In our terminology, a path in the programming language implementation is a unique way to identify a name within code. It must be unique in whatever namespace it can be addressed using. For example, in Java a path to a static final variable (the closest to a global value that is allowed) would be the fully qualified name of the class (package name followed by a dot and the class name) followed by a dot and the name of the variable. With this fully qualified name there is no other variable in a collection of loaded classes that can be confused with it. There may, of course, be conflicting package names in the universe of programs which would cause problems if modules with the same path could be loaded simultaneously.

In an exemplary implementation of our methods, the language has fully qualified names consisting of a package name followed by a dot, followed by a module name followed by a dot, followed by a variable name. This is coupled with a SHA1 hash of the module implementation so that having a collision of names in the universe of programs is unlikely. Our language happens to allow a program to search the internet for a desired module, but this is not a limitation of our methods—any reasonable namespace management scheme will work with our methods. It is convenient from an implementation standpoint if the concept of path coincides with selecting a name from a module, but this is not necessary.

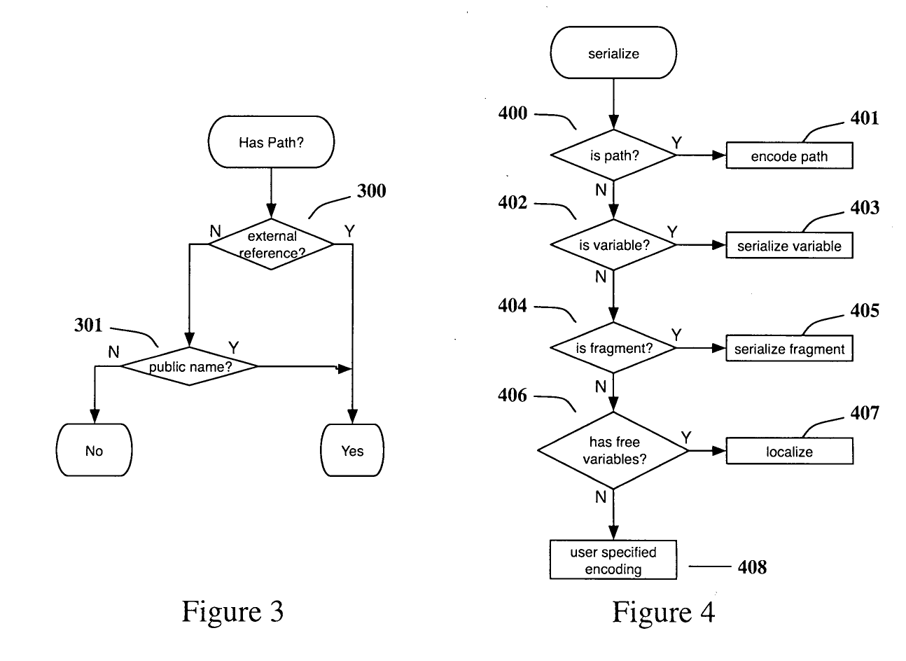

In order to make use of paths in our methods we need to be able to determine whether a name in a program has a path associated with it or not. FIG. 3 depicts the process for determining if a name has a path associated with it. The answer depends on processes for 300 and 301 which determine if the name is external or public, respectively. Simply put, a name is public if it can be referred to outside the module it is defined in, and a name is external if it is defined outside of the module it is referenced in.

B.2. Program Fragments

For our purposes here, a program fragment is an incomplete program. A program is incomplete if it refers to other programs or program fragments. A program fragment is defined to be a non-closed expression: an expression with free variables. For definitions of free, bound, closed, and open, see Pierce (2002), or H. P. Barendregt, The Lambda calculus, its syntax and semantics, Studies in Logic and the Foundations of Mathematics, North Holland, v104, 1984. In order to serialize a program fragment, we must resolve all of the free variables in such a way that deserialization can reconstruct an appropriate context for the fragment.

A common technique for resolving free variables is to create a closure, in which the appropriate definitions of variables are packaged with the referencing fragment. Our system modifies this technique by allow variables with a path representation to be left free in the fragment. Therefore, in our system, a closed fragment may still contain references to paths.

B.3. Classifying Variables

In order to serialize and deserialize arbitrary expressions, we must be able to serialize and deserialize variables that may appear in the expression. We classify by: the context in which it appears, the structure of the variable, and the expression the variable represents.

For a strongly typed language, we can represent this information in the types of variables and their operations. While our technique could also use a static analysis to recover this information from a program, a sufficiently expressive type system allows us to layer our analysis on top of the existing type inference and type checking algorithms. The example pseudo-code below shows one method for encoding the relevant information about variables into an existing type system.

### Pseudocode Excerpt No. 1: Default Strategy for Classifying Mutable State

```
class Monad m => Read m v where
  read :: v a -> m a
class Read m v => Alloc m v where
  alloc :: a -> m (v a)
class Alloc m v => Write m v where
  write :: v a -> a -> m ( )
instance Monad m => Read m Pure where
  read (Pure x) = return x
-- reference cells in an IO context
instance Read IO IORef where read = readIORef
instance Alloc IO IORef where alloc = newIORef
instance Write IO IORef where write = writeIORef
-- Transactional Variables in a transactional context
instance Read STM TVar where read = readTVar
instance Alloc STM TVar where alloc = newTVar
instance Write STM TVar where write = writeTVar
-- Transactional Variables in a IO context
instance Read IO TVar where
  read = atomically . readTVar
```

This example uses three features of the Haskell language that may be unfamiliar to those outside the Haskell community, so they require some explanation. First, it uses the typeclass mechanism which allows us to call different function implementations based on the type of an argument (or arguments); this is conceptually similar to dynamic dispatch in a language like Java in its use but the dispatch is statically determined instead of at runtime. Secondly, we are using higher-order types for additional expressiveness: v and m are each higher-order type constructors that, in this excerpt, take a type variable as argument. Third, the type variable m has been constrained to be an instance of typeclass Monad, which encapsulates a general sequencing mechanism in Haskell. The particular monad instance the type inference system produces can capture the relevant information about the context for our purposes. For more information about monads in programming languages see Wadler, Comprehending monads, proceedings of the 1990 ACM Conference on LISP and Functional Programming, Nice France, New York, N.Y., p. 61-78, 1990. Our example implementation makes use of these advanced type system features as a static analysis to determine the way in which each variable is being used—this is not limiting: in languages that do not support this kind of piggybacking on the type system one may create a static program analysis within the compiler, or analyze the context of expressions dynamically in an interpreter.

In explanation of the above, suppose that the programming language code in question uses read and write whenever accessing the contents of any variable, be it mutable or immutable. The examples of class instances that follow the class definition above illustrate several different kinds of variables we may encounter, each of which may be serialized in a different way. For example, the first instance supposes a “pure” variable—an immutable value. This instance would run its computation in the Pure Monad (this is not a standard Monad in Haskell, but rather part of a library of code developed as part of our language implementation—the details of its implementation are not important to the method of serialization), which insists that there are no side effects such as printing or modifying variables. This should be very easy to serialize because the code does not access a mutable cell. Other instances allow different kinds of side-effects. Many more instances could be supplied to handle different kind of variables within different kinds of contexts. The system can also be extended by programmers to include new kinds of variable and monads not included in the basic design.

B.4. Serialization

The challenge of serializing an expression lies in the serialization of effects. This is challenging because there are several potential strategies for serializing a side-effecting computation. The methods for classifying variables in the previous section enable us to define a general, programmer-extensible base case for serializing arbitrary expressions. For an arbitrary side-effecting computation, we must first decide upon the appropriate strategy, which our methods enable, and then perform the serialization in an automatic way, which our methods also enable. For explanatory purposes, we will use a simple core language that includes paths, variables, local closures, and possibly other language constructs. A path represents a reference to an externally defined expression. A local closure captures a set of variable bindings together with an expression that depends on those bindings. Not all programming languages contain variables or local closures. Our techniques can be applied to such languages: where our process constructs local closures, a semantically appropriate substitution mechanism could also be used.

### Pseudocode Excerpt No. 2: A Simple Core Language

```
type Env = [(Var,Expr)]
data Expr
  = Path Path -- external reference
  | Var Var -- variable
  | Let Env Expr -- local closure
  -- etc...
```

The serialize function in the pseudo-code represents an exemplary implementation of the serialize process in FIG. 4. This process is also depicted as pseudo-code in Excerpt No. 3.

### Pseudocode Excerpt No. 3: Serialization for a Simple Core Language

```
serialize :: Expr -> Binary
serialize (Path p) = encodePath p
serialize (Var v) = serializeVar v
serialize (Let env e) = serializeFragment env e
serialize expr
  | null (fv expr) = userEncoder expr
  | otherwise = localize expr
```

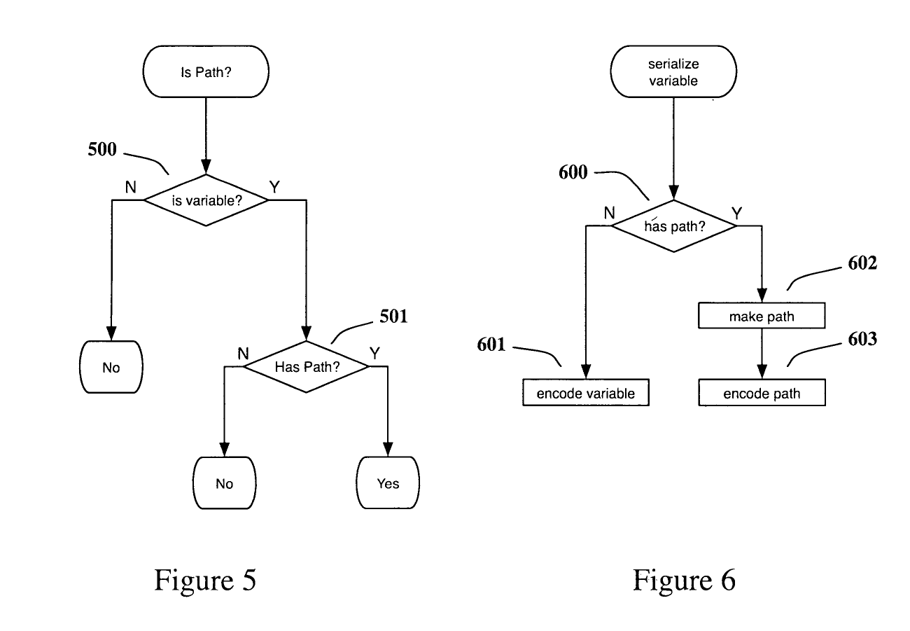

In 400 we decide whether the expression under examination is a path. In our exemplary implementation a path is part of the core language and therefore is trivial to distinguish from other forms of expression—if this were not the case then one could use the method depicted in FIG. 5 as follows: in 500 we determine if the expression is a variable (this should be primitive to the language implementation) if it is then in 501 we ask if the variable name has a path according to the method depicted in FIG. 3 which gives us the answer, in all other cases the answer is no. Once 400 has determined if the expression under examination is a path, by whatever means, if it is a path then we run 401 to encode the path as a serialized value. In an exemplary implementation, encoding a path would be accomplished by encoding a pair of a tag that uniquely identifies the data as a path along with a string representation of the path. If 400 determines that the expression is not a path then the serialization method proceeds to 402 where we ask if the expression under examination is a variable. This is assumed to be something that the language implementer can distinguish. Our exemplary implementation distinguishes variables at the core language level and therefore the implementation of 402 is made trivial. If 402 determines that the expression is a variable then we serialize the variable in 403. Serializing a variable is depicted in FIG. 6, and is also depicted in pseudo-code in Excerpt No. 4.

### Pseudocode Excerpt No. 4: Serialization for a Simple Core Language

```
serializeVar :: Var -> Binary
serializeVar v =
  if hasPath v
  then encodePath (makePath v)
  else encodeVar v
```

First 600 determines if the variable has a path, according to the method depicted in FIG. 3. If the variable does not have a path then 601 encodes the variable according to the representation of a variable in that context—in an exemplary implementation this is accomplished by serializing a pair with a tag that identifies the value as representing a variable along with a string representation of the variable. Another exemplary implementation uses de Bruijn indices (Nicolaas Govert de Bruijn, Lambda-calculus notation with nameless dummies, a tool for automatic formula manipulation, with application to the church-rosser theorem, Indagationes Math, v34, p. 381-392, 1972), encoding the variable for serialization as a pair with a tag to identify the value as representing a variable along with an integer de Bruijn index.

If 600 determines that the variable does have a path then we proceed with 602 which creates a path from the variable. The process of creating a path from a variable depends on the particular language implementation as discussed in the subsection on paths. In our exemplary implementation paths are top-level names in a module, and a representation of a path is just the fully qualified name of the variable. After 602 creates a path from the variable 603 encodes the path as has already been described in the context of 401.

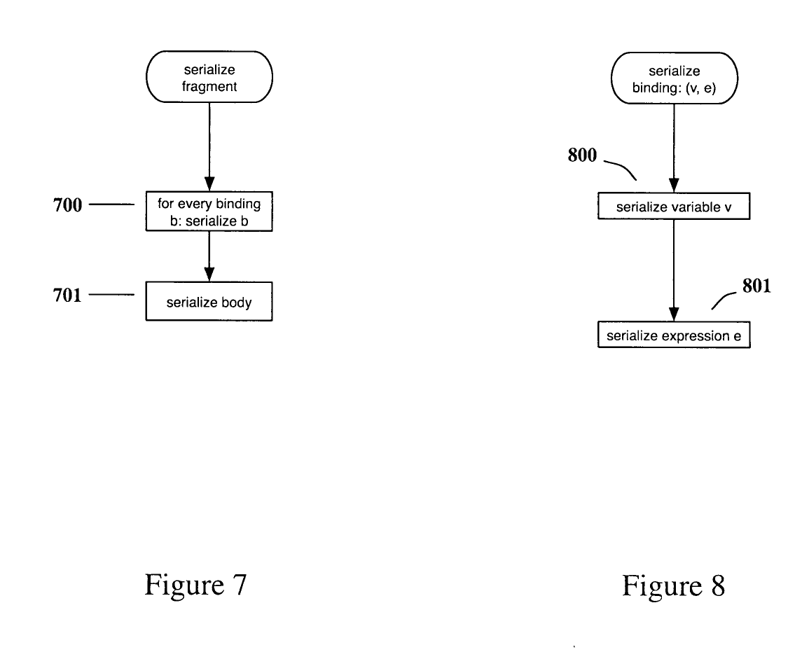

Now we have described what happens if 403 runs; if 402 had determined that the expression under examination is not a variable then FIG. 4 proceeds to 404, which determines if the expression is a fragment. If it is a fragment then we run 405 to serialize the fragment. The fragment is serialized according to the method depicted in FIG. 7, which is also depicted as pseudo-code in Excerpt No. 5. In FIG. 7 we start serializing a fragment by running 700, which serializes the environment of the fragment. It accomplishes this by serializing each binding that is in the environment (an environment is simply a set of bindings: variable/expression pairs). Serializing a binding is accomplished according to the method depicted in FIG. 8. First the variable of the binding is serialized in 800, according to the method of FIG. 6. Second, the expression being bound is serialized in 801 according to the method in FIG. 4. The results of those two are combined by to form the serialization of the binding. Once 700 has serialized every binding in the environment we proceed to serialize the body of the fragment in 701. The body is an expression, so this again is accomplished according to the method in FIG. 4.

### Pseudocode Excerpt No. 5: Serialization for a Simple Core Language

```
serializeFragment :: [(Var,Expr)] -> Expr -> Binary
serializeFragment env e2 =
  forAll env serializeBinding ++ serialize e2
serializeBinding :: (Var,Expr) -> Binary
serializeBinding (v,e) =
  serializeVar v ++ serialize e
```

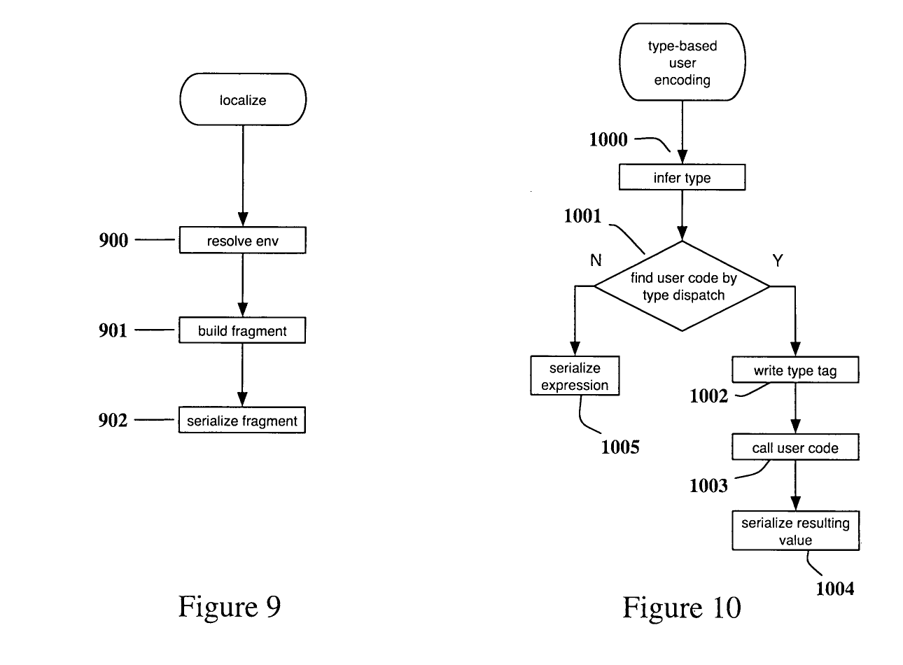

If 404 had determined that the expression under examination is a fragment then we serialize the fragment in 405 as the paragraphs above describe in detail. Otherwise the expression is not a fragment and we run 406 to check if the expression has free variables. Determining if an expression has free variables is a basic operation to any programming language implementation. If the expression does have free variables then we run 407 which localizes the expression to serialize it. The process of localizing an expression is depicted in FIG. 9. First 900 resolves the environment, by finding all free variables that cannot be represented as paths and looking up the definitions of this variables in the current context. Our pseudo-code, shown in Excerpt No. 6, accomplishes this by using the predicate local derived from the “Has Path” process show in FIG. 3, and a function, findVar, for looking up variable definitions in a context. Next 901 builds the fragment. This is done by creating a closure over all of the variables identified in the previous step. Up to this point, except for the consideration of paths, this process is similar to the well-know technique of Lambda Lifting (Thomas Johnsson, Lambda lifting: transforming programs to recursive equations, proceedings of the Conference on Functional Programming Languages and Computer Architecture, Nancy, France, Springer-Verlag, New York, N.Y., p. 190-203, 1985). Finally, 902 serializes the fragment that was built according to the method in FIG. 7.

### Pseudocode Excerpt No. 6: Localization for Serialization

```
localize :: Expr -> Binary
localize expr =
  do locals <- filter local (fv expr)
    exprs <- map findVar locals
    env <- zip locals exprs
    serialize (Let env expr)
```

If 406 had determined that the expression under examination does not have free variables then we run 408 which attempts to allow user code to serialize the expression, and failing that falls back on default serialization methods for a closed expression. FIG. 10 depicts an (optional) technique for finding and invoking user code to serialize an expression based on the type system of the language. Although it is not necessary to have a type system to use our methods, one exemplary implementation uses the type system to guide this part of the serialization process according to FIG. 10. This process is also depicted as pseudo-code below in Excerpt No. 7.

### Pseudocode Excerpt No. 7: User Encoding of Expressions for Serialization

```
userEncoder :: Expr -> Binary
userEncoder expr =
  case lookupUserEncoder expr of
    Nothing -> encodeExpr expr
    Just fn -> tag User expr ++
      serialize (apply fn expr)
tagUser :: Expr -> Binary
tagUser expr = encodeType (inferType expr)
lookupUserEncoder :: Expr -> Maybe Expr
lookupUserEncoder expr =
  typeDispatch “encode” (inferType expr)
```

Since our process allows for user specified encoders, we can use this to provide a set of standard encoding (and decoding) mechanisms which can be modified or replaced as needed. For example, we can use the classification of variables described previously to provide default implementations for serializing any variable found in an expression. One exemplary implementation is shown below in Excerpt No. 8. In this implementation we use the type and context appropriate read function to get the contents of a variable and then encode the result, possibly invoking other standard or programmer-specified encoding schemes.

### Pseudocode Excerpt No. 8: Default Strategy for Serializing Mutable State

class Serialize m a where encode :: a -> m Expr
instance (Read m v,Serialize m a)
=> Serialize m (v a)
where encode v = do x <- read v ; encode x

B.5 Deserialization

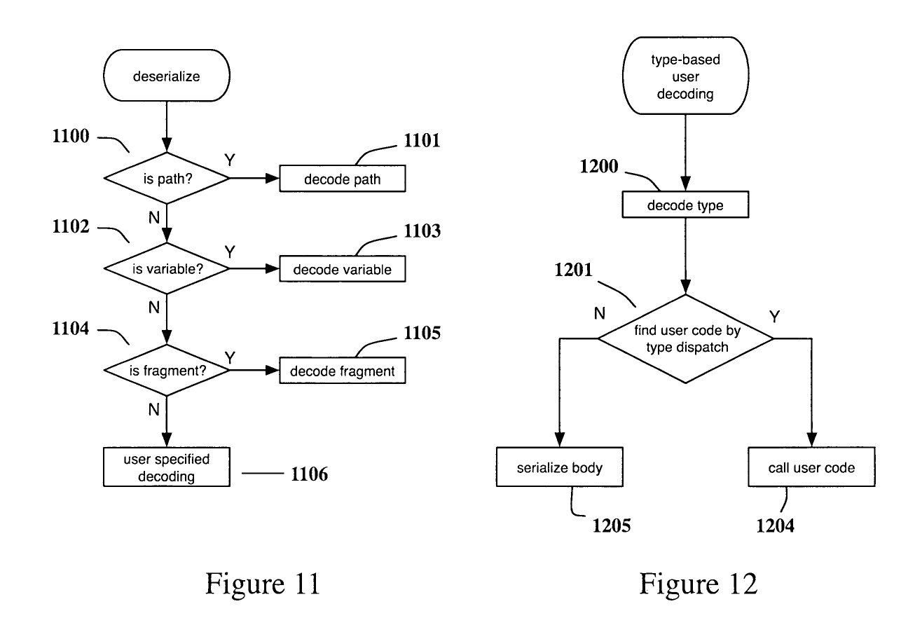

The deserialization process is depicted in FIG. 11, and also in Excerpt No. 9. To perform deserialization this method first runs 1100, which asks if the binary data can be decoded as a path, if so, then the path is decoded by 1101, which is the inverse of the path encoding process described previously. If the binary data is not a path, then 1102 asks if the data represents a variable, and if so it is decoded in 1103, which is the inverse of the encoding process for variables described previously. Otherwise, node 1104 asks if the binary stream represents a fragment, and if so it is decoded in 1105, which is the inverse of the encoding process for fragments described previously.

### Pseudocode Excerpt No. 9: Simplified Example Function for Deserializing

```
deserialize :: Expr -> OpenExpr
deserialize frag =
  do ctx <- currentContext
    case frag of
      Path p -> decodePath p
      Var v -> decodeVar v
      Let env e -> decodeFragment env e
      e -> userDecoder ctx e
decodeFragment :: Env -> Expr -> OpenExpr
decodeFragment env e =
  do env' <- map decodeBinding env
    e' <- decodeExpr e
    return (Let env' e')
decodeBinding :: (Var,Expr) -> (Var,Expr)
decodeBinding (v,e) =
  do e' <- decodeExpr e
    return (v,e')
```

Like the serialization process, the deserialization process also allows for programmer-specified decoding schemes. In node 1106, we know that the expression is a closed expression, and we allow a user specified decoding scheme to be used. This process is show in FIG. 12, and Excerpt No. 10, below. First, in 1200, we must decode the type of the encoded expression. Then, in 1201, we attempt to dispatch to user-defined code. If this fails, then we use a default deserialization as shown in node 1205. Otherwise, we can call the user code to deserialize the expression at node 1204.

### Pseudocode Excerpt No. 10: Simplified Example Function for User-Specified Deserializing

```
userDecoder :: Ctx -> Fragment -> OpenExpr
userDecoder ctx e =
  case lookupUserDecoder ctx e of
    Nothing -> decodeExpr e
    Just fn -> return (apply fn e)
lookupUserDecoder :: Ctx -> Fragment -> Maybe Expr
lookupUserDecoder ctx e =
  typeDispatch “decode” (buildContextType ctx (typeOf e))
```

The functions above accomplish deserialization by calling helper functions, as illustrated in FIG. 11. Also, like the case of serialization, we are able to provide default schemes for handling expressions using the user-extension mechanism described. For example, we can specify a dual to the definitions given in Excerpt No. 8 for performing deserialization of arbitrary variables within an arbitrary context. This is shown below in Excerpt No. 11. In this example, a variable is decoded, and then allocated and returned according the context and type of variable required. Pseudocode Excerpt No. 11 Default strategy for deserializing mutable state

class Deserialize m a where decode :: Expr -> m a
instance (Alloc m v,Deserialize m a)
=> Deserialize m (v a)
where decode s = do x <- decode s ; alloc x

C. Network-Aware Open Dynamic Dispatch

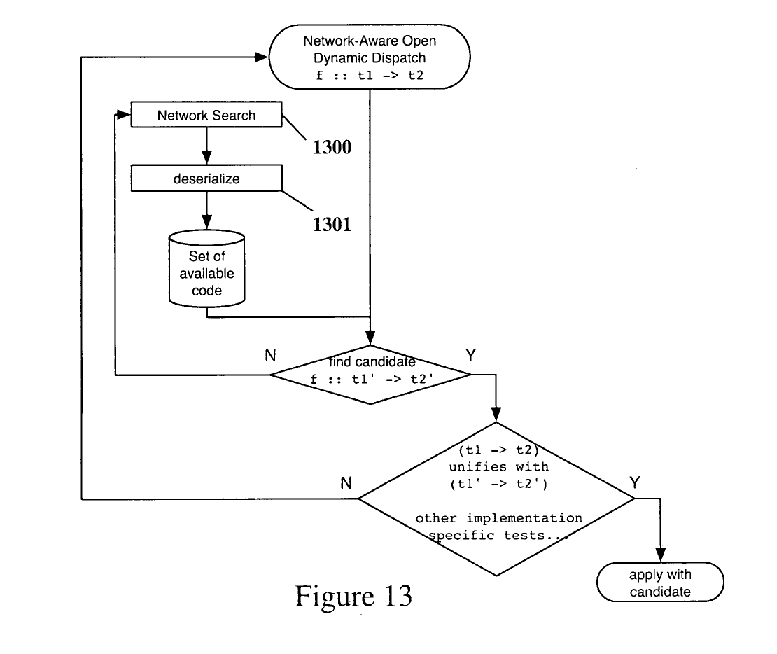

Our method of network-aware open dynamic dispatch extends the capabilities of open dynamic dispatch by allowing the search process to extend over a network, loading serialized program fragments into the set of available code. Network-aware open dynamic dispatch is the combination of our method of deserialization, standard techniques for looking up data over a network, and our method of open dynamic dispatch. This technique also forms the basis for our method of automatic software installation in response to events. The only changes needed to FIG. 2, which illustrates open dynamic dispatch without network awareness, are to change block 203 to use a method of searching on a network, and the results from the search must then be deserialized before being added to the set of available code. FIG. 13 illustrates the method of network-aware open dynamic dispatch. Block 1300 performs the network search, instead of the less specific search of 203 from FIG. 2. Block 1301 deserializes any search results from 1300 before entering them into the set of available code.

One exemplary implementation uses a client-server model for the network search, in which a database of code residing on a server is queried over the network for program fragments with functions matching the desired name. Another exemplary implementation uses a peer-to-peer model for the network search, keeping program fragments in a hashtable distributed among peers on the network. The distributed hashtable algorithm could be any well-known algorithm from the networking literature, for example the Kademlia algorithm (Maymounkov and Mazières, 2002).

D. Automatic Software Installation in Response to Events

Using our methods for network-aware open dynamic dispatch we can create a particular method for reacting to events, such as receiving a serialized program fragment or other data. We define a specific type-indexed function; one exemplary implementation uses the typeclass mechanism to accomplish this:

### Pseudocode Excerpt No. 12 Example Dispatch Function for Receiving Messages

class Recv a where
recv :: a -> IO ( )

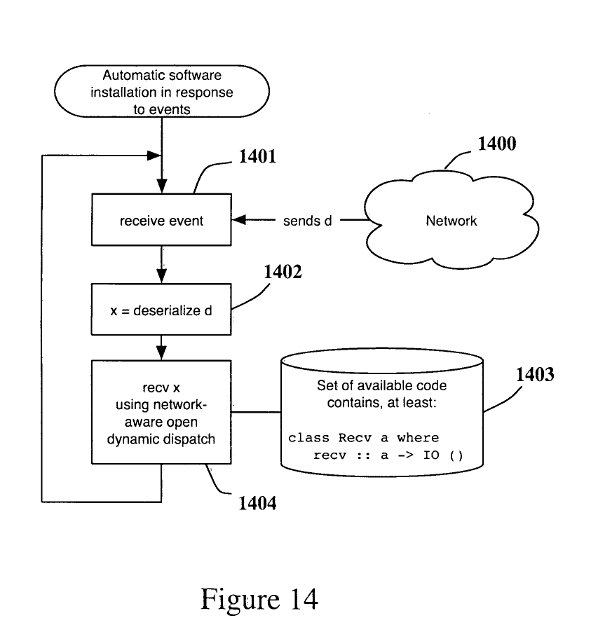

The typeclass Recv in this example is parameterized by a type variable a. This represents the type of the value that we are reacting to during the event. So, for example, in a network event the runtime system receives a packet that is determined to be serialized. It deserializes the program fragment and uses network-aware open dynamic dispatch on the function recv, in effect asking to search the system and the network for ways to handle receiving a program fragment of whatever the type is. This method is illustrated in FIG. 14. Automatic software installation in response to events begins by an event taking place. In FIG. 14 this is illustrated as a network event: in 1400 some datum “d” is sent from the network to the runtime environment. In block 1401 the runtime environment receives the network event. Next, in block 1402, the datum d that was received is deserialized according to the our methods for deserialization, and we refer to the value deserialization returns as x. Following this, block 1404 calls the function recv with x using the our method for network-aware open dynamic dispatch. In addition, we require for this method that the set of available code, represented as 1403 be populated from the beginning with at least the definition for the recv function. When block 1404 is done with its dispatch we return to the beginning of the method for automatic software installation in response to events where we wait for another event to occur.

Because of the behavior of deserialization coupled with the behavior of network-aware open dynamic dispatch, when we receive a network event we may also automatically install new software to handle the type of program fragment that is deserialized.

In an exemplary implementation the first peer we search for the appropriate recv function from is the peer we received the serialized value from. If they had the ability to send the value then it is likely they have the appropriate code to receive and act on such a value as well.

E. Zero-Configuration Software

We've described several methods related to mobility of effectful program fragments, some fundamental methods and some that build and extend the fundamental methods. One particularly useful method that builds on our fundamental methods is what we've termed “zero-configuration software”. Many languages define a particular function symbol, usually “main”, as the entry point for execution. Likewise, building on our methods, zero-configuration software defines a well-known symbol that is overloaded by each program fragment that wishes to have its own entry point. One exemplary implementation uses the following definition:

### Pseudocode Excerpt No. 13 Example Dispatch Function for a Program Entry Point

class Program a where
main :: a -> IO ( )

Our language definition then expects a program entry point to be any overloading of the typeclass Program, and the definition of main is where execution begins. If you wish to send a program to another runtime environment, say over a network, according to the zero-configuration method of doing so you first define a datatype that uniquely identifies this entry point—in an exemplary implementation this is easily accomplished by defining a datatype that is not exported by the module. For example,

data MyProgram = MyProgram
instance Program MyProgram where
main _{—} = −− definition of your program
-- etc...
send peer (main MyProgram)

In this example the send function first serializes the program fragment and then sends the resulting binary form to a peer on the network. What this accomplishes is that there is guaranteed a single instance of your program when you send it, so there can be no ambiguity, and the entire program will be bundled up using our other methods to be sent, and then received on the other end. Connecting this to our method for automatic software installation in response to events is also a simple matter for our language implementation:

instance Program a => Recv a where
recv x = when (isGood x) (main x)

Now we have a system that will run the dedicated entry point whenever receiving an instance of Program. In the pseudocode above we have added a test called “isGood”, which could be any predicate, but is there to guard against automatically executing code that a user may not wish to. In one exemplary implementation the runtime environment includes providence information as well as levels of trust for peers that may have supplied the program fragment—is Good is then defined to only run code from trusted sources.

In addition, because we can always load a needed module or program from peers on our network, we are able to start with a very minimal set of program fragments in our set of available code; in one exemplary implementation we start with only the typeclass definitions for Recv and Program, and those needed by serialization and deserialization. Everything else is obtained on-demand.

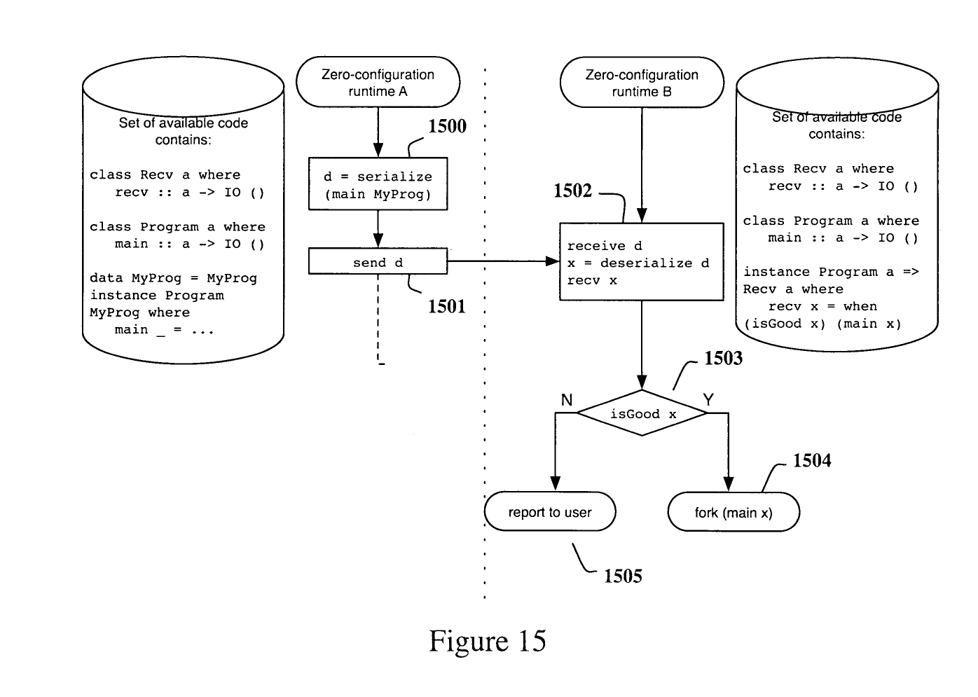

This method is illustrated in FIG. 15, which shows two runtime environments that use zero-configuration. Runtime A is shown on the left of the figure and runtime B is shown on the right. Each has a set of available code, with some minimal definitions for the example shown. In this case, runtime A is sending its main program to runtime B, so the set of available code for runtime A must include its datatype definition that identifies its main program along with an instance declaration that defines the code of runtime A's main function. Runtime B knows about main functions as a typeclass but does not have runtime A's definitions yet. Runtime A begins at block 1500, which serializes its main function along with the datatype that uniquely identifies its instance and stores that as “d”. Then, in block 1501, runtime A sends d over the network to runtime B. In block 1502 runtime B receives d, deserializes it, and calls recv on that, which may need to use network-aware open dynamic dispatch to resolve the instance by pulling more code from the network. Because of the instance definition that makes any Program a Recv that zero configuration requires for the set of available code, runtime B proceeds to block 1503 where it asks if the value it has received “is Good”. If it is then 1504 forks a new thread of execution and calls main on the value, thereby executing the main program that runtime A had sent. If the value is determined by 1503 not to be good, then 1505 may report this to the user in some way.

Although the invention has been described with reference to specific embodiments, these descriptions are not meant to be construed in a limiting sense. Various modifications of the disclosed embodiments, as well as alternative embodiments of the invention, will become apparent to persons skilled in the art upon reference to the description of the invention. It should be appreciated by those skilled in the art that the conception and the specific embodiment disclosed might be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore contemplated that the claims will cover any such modifications or embodiments that fall within the true scope of the invention.

What is claimed is:

1. A method of dispatching on a function call of a selected type during execution of software code by a computer system, comprising:
searching an available set of code based on at least function name for candidate code for implementing a selected function;
if candidate code is found, performing unification on type variables within the candidate code to determine the suitability of the candidate code;
if the type variables unify, dispatching to the candidate code to implement the selected function; and
if candidate code is not found, dynamically expanding the set of available code and searching for candidate coded in the expanded set of available code.

2. The method of claim 1, wherein dynamically expanding the set of available code comprises dynamically expanding the set of available code with an interpreter operating on source code to merge definitions.

3. The method of claim 1, wherein if the type variables do not unify after performing unification:
dynamically expanding the set of available code and searching for candidate code in the expanded set of available code.

4. The method of claim 1, wherein dynamically expanding the set of available code comprises searching a network.

5. The method of claim 4, further in response to searching the network, de-serializing results from the search prior to entering the results in the set of available code.

6. A method of determining whether a variable name within a set of software code being executed on a computer is associated with a path comprising:
testing if the variable name is defined within the code but outside a code module referencing the variable name;
if the variable name is defined outside the code module referencing the variable name, determining that the variable name is an external variable name associated with a path; and
if the variable name is defined within the code module:
testing if the variable name can be referenced by code outside of the code module defining the variable name;
if the variable name can be referenced by code outside of the code module defining the variable name, determining that the variable name is a public variable name associated with a path; and
if the variable name cannot be referenced by code outside of the code module defining the variable name, determining that the variable name is a not public variable name and is not associated with a path.

7. A method of serializing an expression defined in programming code running on a computer into binary data, comprising:
testing the expression with the computer; and
selectively performing serialization operations with the computer in response to testing the expression:
if the expression is a path, encoding the path;
if the expression is a variable, serializing the variable;
if the expression if a program fragment, serializing the program fragment; and
if the expression has free variables, localizing the free variables.

8. The method of claim 7, wherein encoding the path comprises encoding a pair including a tag that identifies the expression as a path and a string representation of the path.

9. The method of claim 7, wherein serializing the variable comprises:
determining if the variable is associated with a path;
if the variable is not associated with a path, encoding the path; and
if the variable is associated with a path, making a path and encoding the path.

10. The method of claim 7, wherein serializing the program fragment comprises:
for each binding, serializing the variable; and
serializing the body of the program fragment.

11. The method of claim 10, wherein serializing each binding comprises:
serializing the variable of the binding, comprising:
if the variable is not associated with a path, encoding the path; and
if the variable is associated with a path, making a path and encoding the path; and
serializing the expression of the binding, comprising:
testing the expression; and
selectively performing serialization operations with the computer in response to testing the expression:
if the expression is a path, encoding the path;
if the expression is a variable, serializing the variable;
if the expression if a program fragment, serializing the program fragment; and
if the expression has free variables, localizing the free variables.

12. The method of claim 7, wherein localizing the free variables comprises:
identifying all free variables that cannot be represented as paths;
looking-up variable definitions for identified variables in an associated context;
building a program fragment by creating a closure over the identified variables; and
serializing the program fragment.

13. The method of claim 7, further comprising:
if the expression does not have free variables, finding and invoking code within the program code running on the computer to serialize the expression based on the type system of a language in which the programming code is written.

14. The method of claim 13, wherein finding and invoking code comprises:
inferring a type for the expression;
searching for code by implementing a type dispatch;
if code is not found, serializing the expression; and
if code is found:
writing a type tag for the expression;
call the code; and
serializing a resulting value.

15. A method of de-serializing binary data with a computer to generate an expression in a corresponding programming code, comprising:
testing the expression with the computer; and
selectively performing de-serialization operations with the computer in response to testing the expression, comprising:
if the binary data can be decoded as a path, decoding the binary data as a path;
if the binary data cannot be decoded as a path but can be decoded as a variable, decoding the binary data as a variable; and
if the binary data cannot be decoded as a path or a variable and can be decoded as a program fragment, decoding the binary data as a program fragment.

16. The method of claim 15, further comprising performing user specified decoding if the binary data cannot be decoded as a path, a variable, or a fragment, including:
decoding the type of expression represented by the binary data;
in response to decoding the type of expression, attempting to dispatch to corresponding user-defined code for decoding the binary data;
if the attempt to dispatch to corresponding user-defined code is successful, call the corresponding code; and
if the attempt to dispatch to corresponding user-defined code fails, call default code.

17. A method of installing software on a computer comprising:
receiving binary data with the computer from an external source;
de-serializing the binary data;
performing a dispatch to retrieve code for operating on the de-serialized data; and
installing the retrieved code on the computer and operating on the de-serialized data.

18. The method of claim 17, wherein performing the dispatch comprises performing a dispatch to another computer communicating with the computer via a network.

19. The method of claim 17, where de-serializing the data comprises:
testing the data with the computer; and
selectively performing de-serialization operations with the computer in response to testing the data, comprising:
if the binary data can be decoded as a path, decoding the binary data as a path;
if the binary data cannot be decoded as a path but can be decoded as a variable, decoding the binary data as a variable; and
if the binary data cannot be decoded as a path or a variable and can be decoded as a program fragment, decoding the binary data as a program fragment.

20. The method of claim 17, wherein performing the dispatch comprises:
searching an available set of code based on at least function name for candidate code for operating on the de-serialized data;
if candidate code is found, performing at unification on type variables within the candidate code to determine the suitability of the candidate code;
if the type variables unify, dispatching to the candidate call to implement the selected function; and
if candidate code is not found, dynamically expanding the set of available code and searching for candidate in the expanded set of available code.

21. A method of exchanging program code via a network using zero-configuration software comprising:
designating with a plurality of machines participating in zero-configuration a single overloaded function name as an entry point into programming code, the overloaded function name corresponding to a entry point function which takes a parameter;
on a first computer, defining a non-public datatype;
on the first computer, overloading the designated entry point function with a program fragment for the non-public datatype;
on the first computer, serializing the program fragment defined by applying the entry point function to the non-public datatype;
sending the serialized program fragment from the first computer to a second computer via the network;
receiving the serialized program fragment with the second computer;
on the second computer, deserializing the serialized program fragment and selectively running the program fragment with network-aware open dynamic dispatch.

22. The method of claim 21, further comprising performing a dispatch from the second computer to retrieve from a source on the network additional code for running the program fragment.
